(19) United States
(12) Patent Application Publication
(10) Pub. No.: US 2011/0040421 A1
(43) Pub. Date: Feb. 17, 2011

(54) INSTALLATION FOR THE PRODUCTION AND STORAGE OF RENEWABLE ENERGY

(75) Inventors: Alexis Duret, Lausanne (CH); Erik Jan Frenkel, Neuchatel (CH); Don Corson, Yverdon-les-Bains (CH)

Correspondence Address: GRIFFIN & SZIPL, PC, SUITE PH-1, 2300 NINTH STREET, SOUTH, ARLINGTON, VA, 22204, US

(73) Assignee: SWISS HYDROGEN POWER SHP SA, Fribourg (CH)

(21) Appl. No.: 12/682,416

(22) PCT Filed: Oct. 6, 2008
(86) PCT No.: PCT/EP08/63346

§ 371 Date: Jul. 28, 2010

(30) Foreign Application Priority Data
Oct. 9, 2007 (EP) 07118132.5

(51) Int. Cl. H02J 3/38; H01M 8/06; H01L 31/042; G06F 1/26

(52) U.S. Cl. 700/295; 429/416; 136/244; 307/45

(57) ABSTRACT

Installation for the production and storage of renewable energy (1) provided for supplying an electricity-consuming unit (2) with electricity, the installation comprising solar panels (3) and a hydrogen production unit (4, 7, 8, 9, 10), which comprises an electrolyser (4) provided to produce hydrogen and oxygen when powered by the solar panels (3), a tank (8), and a compressor (10) for injecting the hydrogen provided by the electrolyser into the tank. The installation is characterised in that the solar panels (3) are provided to supply the electricity which they produce as a priority to the electricity-consuming unit (2) until the connected load of the unit is reached. Furthermore, the installation (1) comprises a branch connection unit (6) connected to the output of the solar panels and provided to direct a part of the electricity produced to the electrolyser (4) when the power produced by the solar panels exceeds the connected load.

This is a National Phase Application in the United States of International Patent Application No. PCT/EP2008/063346 filed Oct. 6, 2008, which claims priority on European Patent Application No. 07118132.5, filed Oct. 9, 2007. The entire disclosures of the above patent applications are hereby incorporated by reference.

### BACKGROUND OF THE INVENTION

The present invention relates to an installation for the production and storage of renewable energy and in particular of photovoltaic electricity. The present invention relates more particularly to an installation of this type in which at least part of the renewable energy produced is converted into electrochemical energy for storage by decomposing water into hydrogen and oxygen.

Patent document US 2005/109394 discloses an installation of the above type. The disclosed installation is a decentralised installation, which is intended to be fitted in a house, a public building, a hospital or even a factory, for example. This installation comprises a hydrogen production unit consisting of an electrolyser, a compressor and a storage vessel for compressing and storing the hydrogen produced by the electrolyser, the electrolyser being powered by solar panels. The installation further comprises a fuel cell for generating electricity from hydrogen and a control unit comprising an inverter, a microcontroller and a modem. The electricity generated by the fuel cell is either used on site or fed into the grid.

An installation of the type described above has a number of advantages: solar energy is a universally available form of renewable energy, the electrolyser only consumes a small amount of water, the production of electricity in the fuel cell from hydrogen does not release any pollutants, etc. Moreover, since solar energy is used to produce hydrogen, which can be stored, this type of installation makes it possible to store solar energy without resorting to conventional batteries, which have a considerable production cost.

However, installations of the same type as that disclosed in the above-mentioned document have some drawbacks. In particular, hydrogen production by electrolysis using solar energy is far too expensive to be competitive. In particular, at the moment, the average efficiency of the conversion of solar energy into hydrogen is no more than 6%. Therefore, the lower the efficiency of the solar panels provided with an installation, the greater the surface area they have to cover. As a result, the installation costs are correspondingly increased. By contrast, it is known that a fuel cell powered by hydrogen has an efficiency of approximately 60%. In the end, an installation of the above type only supplies electricity at an average energy efficiency of less than 4%.

### SUMMARY OF THE INVENTION

It is an object of the present invention to reduce the production cost of the electricity supplied by an installation of the above type by improving the average energy efficiency of the installation. This object is achieved by providing an installation for the production and storage of renewable energy according to a first illustrative embodiment. In accordance with the first illustrative embodiment of the invention, an installation for the production and storage of renewable energy is provided for jointly supplying an electricity-consuming unit connected to the grid, wherein the installation comprises means for generating electricity from renewable energy, an inverter to convert the electricity supplied by the installation to an alternating current compatible with the grid, a hydrogen production unit comprising an electrolyser provided to produce hydrogen and oxygen when powered by the means for generating electricity from renewable energy, a tank, and a compressor for injecting the hydrogen provided by the electrolyser into the tank; characterised in that it comprises a detector provided to measure the electrical power supplied by the grid to the electricity-consuming unit, in that the means for generating electricity from renewable energy are provided to supply the energy that they produce to the energy consumption unit as a priority until the connected load of this unit is reached, and in that the device comprises a branch connection unit connected to the output of the means for generating electricity, and in that the branch connection means are provided to direct electricity to the electrolyser only when the power measured by the detector is negative or zero, in such a way as to direct to the electrolyser the remainder of the electricity produced when the power produced by the means for generating electricity from renewable energy exceeds the connected load.

In accordance with a second illustrative embodiment of the invention, the first illustrative embodiment is modified so that the branch connection means are provided to bring the measured electrical power to zero or to keep it at zero. In accordance with a third illustrative embodiment of the invention, the first illustrative embodiment and the second illustrative embodiment may be further modified so that the hydrogen produced by the hydrogen production unit is provided to supply a fuel cell.

In accordance with a fourth illustrative embodiment of the invention, the third illustrative embodiment is further modified so that the hydrogen produced by the hydrogen production unit is provided to supply the fuel cell of a car, and in that the installation comprises hydrogen transfer means for transferring the hydrogen contained in the tank into a container of the vehicle. In accordance with a fifth illustrative embodiment of the present invention, the third illustrative embodiment is further modified so that the fuel cell is fixed and is part of the installation, and in that the fuel cell is provided to supply the electricity which it produces to the electricity-consuming unit when the power produced by the means for generating electricity from renewable energy is less than the connected load of the unit. In accordance with a sixth illustrative embodiment of the present invention, the second illustrative embodiment and the fifth illustrative embodiment are further modified so that it is provided to instruct the fuel cell to start up when the power measured by the detector is positive, and only at times when the cost of electricity from the grid is high. In accordance with a seventh illustrative embodiment of the invention, the fourth embodiment is further modified so that it comprises a rectifier that makes it possible to supply the electrolyser with the electricity from the grid, so as to increase the amount of hydrogen contained in the tank, only when the cost of the electricity from the grid is low.

In accordance with an eighth embodiment of the present invention, the first illustrative embodiment, the second illustrative embodiment, the third illustrative embodiment, the fourth illustrative embodiment, the fifth illustrative embodiment, the sixth illustrative embodiment and the seventh illustrative embodiment may be further modified so that the hydrogen production unit comprises a second tank and a second compressor for injecting the oxygen provided by the electrolyser into the second tank. In accordance with a ninth illustrative embodiment of the present invention, the eighth illustrative embodiment is further modified so that the oxygen and hydrogen produced by the electrolyser are provided to supply a fuel cell. In accordance with a tenth illustrative embodiment of the present invention, the first illustrative embodiment, the second illustrative embodiment, the third illustrative embodiment, the fourth illustrative embodiment, the fifth illustrative embodiment, the sixth illustrative embodiment, the seventh illustrative embodiment, the eighth illustrative embodiment, and the ninth illustrative embodiment may be modified so that the means for generating electricity from renewable energy are photovoltaic solar panels.

It will be understood that because of the presence of the branch connection means, part of the electricity produced by the electricity generating means from renewable energy can be consumed directly by the electricity-consuming unit (which might for example be a house, a public building, a hospital, or even for example a factory). Since this part of the electricity is not stored, it can be supplied at an improved energy efficiency that can even reach approximately twice that of an installation such as the prior art installation described above. According to Swiss statistics for example, a house provided with an installation according to the present invention, with 63 m2 of solar panels, could immediately consume approximately 30% of the electricity produced by the panels.

In another advantageous embodiment of the present invention, the installation further comprises a fuel cell powered by the hydrogen produced by the electrolyser. Moreover, in an advantageous variant, the entirety of the hydrogen produced is intended to power the fuel cell and therefore to produce electricity. However, it is worth noting that based on the losses linked to the use of the electrolyser and fuel cell, the 30% of the electricity which is supplied directly by the means for producing electricity from renewable energy corresponds in practice to half of the total energy supplied by an installation according to this variant.

It will therefore be understood that direct use of part of the electricity makes it possible to improve the overall energy efficiency of an installation according to the present invention. This efficiency should on average be greater by 50%, in practice, than that of a prior art installation of the type described above.

In a preferred variant of the above advantageous embodiment, the fuel cell is used only when the photovoltaic cells are unable to meet the requirements of the electricity-consuming unit.

In a yet another advantageous embodiment of the present invention, the hydrogen produced is provided as fuel for a car provided with a fuel cell. Since the hydrogen is produced purely from the excess energy provided by the means for generating electricity from renewable energy, the fuel production costs for a hydrogen car are consequently reduced.

Further features and advantages of the present invention will become apparent upon reading the following description, given purely by way of example and referring to the appended FIG. 1.

### BRIEF DESCRIPTION OF THE DRAWINGS

FIG. 1 is a schematic drawing of a device for the production and storage of photoelectrical energy, connected to a fuel cell and in accordance with a particular embodiment of the present invention.

### BRIEF DESCRIPTION OF AN EMBODIMENT

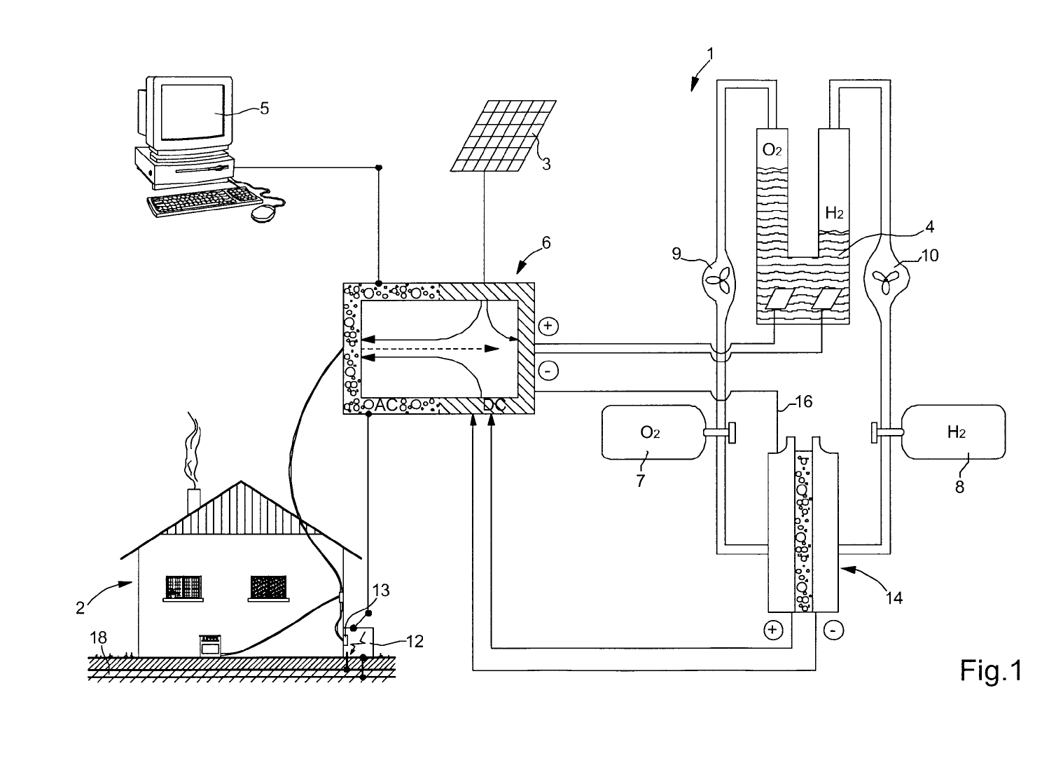

Referring to FIG. 1, an installation 1 for the production and storage of renewable energy corresponding to a particular embodiment of the present invention is shown. It can be seen that this installation 1 comprises in particular means for generating electricity from renewable energy 3 and an electrolyser 4 making it possible to convert the energy supplied by the means 3 into electrochemical energy by separating the hydrogen and the oxygen in water. In a manner known per se, in the present embodiment, the means for generating electricity from renewable energy are formed from a plurality of photovoltaic cells assembled on panels 3 known as solar panels. It will however be understood that in a variant, the means 3 could for example consist of one or more wind turbines, of a generator driven by a water wheel or a water turbine, or of any other device known to the person skilled in the art which makes it possible to produce electricity from renewable energy.

FIG. 1 further shows that the installation 1 is connected in such a way as to power an electricity-consuming unit, which in the present example consists of all the electrical installations with which an individual house 2 is provided. Naturally, instead of the electrical installations with which an individual house 2 is provided, it could equally well consist of, for example, the electrical installations with which a public building, a hospital, or even a factory, etc., is provided. The house 2 is provided not only to be supplied by the installation 1 but also to be jointly supplied by a grid 18 operated by an electricity supplier.

It can further be seen from FIG. 1 that the installation 1 further comprises a central branch connection unit 6, which receives the electricity produced by the solar panels 3. The central unit 6 is provided to receive signals from a user interface 5 so as, in particular, to control the distribution of the energy supplied by the solar panels 3 between the house 2 and the electrolyser 4.

The solar panels 3 provide direct current electricity, whilst the electric installations with which the house is provided are generally provided to operate using alternating current. This is why an inverter (not shown) is also provided in the central unit 6. Because of this inverter, the central branch connection unit 6 is able to supply the house 2 with alternating current having a phase and voltage compatible with those of the grid.

According to the present invention, the electricity provided by the solar panels 3 is devoted to meeting the electricity requirements of the house 2 as a priority. It is only the surplus electricity, or in other words the power produced in excess of the connected load of the house 2, which is branched to the electrolyser 4 so as to be stored in the form of electrochemical energy. “Connected load” refers to the electricity requirements, at a given moment, of all of the electrical installations with which the house 2 is provided. It will therefore be understood in particular that just like the power produced by the solar panels 3, the connected load is a value that fluctuates over time. Since the consumption of the individual house 2 is not regular over the course of a day, the requirements vary as a function of a number of parameters. In fact, in a dwelling, the electricity requirements are different depending on whether it is summer or winter, depending on the time of day and depending on the number of occupants present within the dwelling. Thus, in winter, when there is the least light and the outside temperature is coldest, the lighting and heating requirements are the highest. The electrical current requirements of the dwelling are thus greater than in summer, when the natural light is the strongest and the outside temperature is the highest.

According to the above-mentioned Swiss statistics, the electricity requirements of a typical individual house come to approximately 5,400 kWh per year. Furthermore, 63 m2 of solar panels produce approximately 8,580 kWh per year on average. Naturally, a drawback of solar energy is that it is most often not produced at the moment when it is needed (in particular, solar energy clearly cannot be produced at night, when there is a need for lighting). Nevertheless, according to the above-mentioned statistics, 2,480 kWh of the electricity produced in a year by the 63 m2 of solar panels is produced at the moment when the house requires it. This electricity which is absorbed directly by the connected load corresponds to nearly 30% of the 8,580 kWh of electricity produced in a year by these solar panels. According to the present invention, the remainder of the electricity produced, or approximately 70% thereof, is directed to the electrolyser 4 by the central branch connection unit 6.

In a known manner, the electrolyser 4 uses the electricity to produce hydrogen and oxygen from water. The hydrogen and oxygen are subsequently stored under pressure in two tanks 7 and 8. Two compressors, denoted 9 and 10, make it possible to compress the gas in the tanks 7, 8 to a high pressure (350 bars in the present example). It will be understood that the hydrogen that fills one of the tanks (denoted 8) is suitable for use as a fuel. Moreover, it is known that this gas constitutes a fuel that is not, in principle, a pollutant. Because the hydrogen is stored under pressure, the installation 1 can provide fuel, and thus make it possible to produce energy, at any time. By transforming the solar energy into hydrogen, the installation 1 therefore makes it possible to store the solar energy in a non-polluting manner without resorting to batteries, which are considerably more expensive.

It can further be seen from FIG. 1 that in the present embodiment, the installation 1 also stores the oxygen produced by the electrolyser. As will be seen later, the ability to provide not only hydrogen but also oxygen can be advantageous, in particular when the gases provided by the installation 1 are provided to supply particular types of fuel cells.

As stated above, the house 2 is provided to be supplied not only by the installation 1 but also by the electric grid 18. In the present example, the primary function of the connection of the house to the grid is to make it possible to supplement the electricity supply of the house 2 when the electrical power supplied by the installation 1 is insufficient. As is confirmed in the drawing, the connection of the house 2 to the electric grid 18 is provided at a box, which is denoted 12. In a known manner, an electricity meter is generally installed in the house 2, immediately upstream from the box 12, to measure the amount of electrical energy supplied by the grid.

In the particular embodiment of the present invention to which the present example relates, the central branch connection unit 6 is connected to a current detector (13), which may be combined in a single unit with the electricity meter of the house, and which is provided to measure the flows of electrical power entering and leaving the house 2. Based on the information supplied by the current sensor, the central branch connection unit is able to provide that the power supplied to the house 2 by the installation 1 does not exceed the connected load. In fact, if the electrical power supplied by the installation 1 were to exceed the connected load, the excess electricity would be transmitted from the house to the grid. This flow of energy leaving the house is immediately reported by the detector 13. This report causes the central branch connection unit to increase the electricity that is branched to the electrolyser 4. Conversely, when the electrical power supplied by the installation 1 is not sufficient to cover the requirements of the house, the shortfall is made up by electricity supplied by the grid. This flow of energy entering the house is immediately reported by the detector 13, and this report causes the central branch connection unit to reduce the electricity that is branched to the electrolyser 4. In this way, the energy flow between the house and the grid can be made precisely zero, as long as the electrical power produced by the solar panels at that moment is at least equal to the connected load.

It can further be seen from FIG. 1 that the installation 1 of the present example further comprises a fuel cell 14. The fuel cell 14 is provided to produce electricity from hydrogen and oxygen. For this purpose, the cell 14 is connected to the pressurised gas tanks 7 and 8. It will be understood that in the present example, the oxygen and hydrogen produced by electrolysis are provided to make it possible to produce electricity on demand. The electricity produced by the cell 14 may for example be supplied to the house 2 at the moment when the electrical power produced by the solar panels 3 is less than the connected load in the house.

It can further be seen from FIG. 1 that a command line 16 connects the central unit 6 to the fuel cell 14. In these conditions, it is possible for example to instruct the cell 14 to start up when, firstly, all of the electricity produced by the solar panels is being supplied to the house and secondly, when the current sensor indicates that an energy flow is entering the house from the grid. Specifically, the fact that a contribution is taken from the grid indicates that the electricity supplied by the solar panels is not sufficient to meet requirements, and this indicates that an additional source of electricity is needed.

Many electricity suppliers apply different rates depending on the time of day. In these conditions, in an advantageous variant of the present example, the fuel cell is started up only if the time of day corresponds to a period when the price of the electricity from the grid is high.

It will further be understood that various modifications and/or improvements, which are obvious to the person skilled in the art, can be applied to the embodiment that has just been described without departing from the scope of the present invention as defined by the appended claims. In particular, instead of using a fuel cell of a type that has to be supplied with oxygen as well as hydrogen, it would of course be possible to use a fuel cell that is supplied purely with hydrogen and draws its oxygen from the ambient air.

Furthermore, in another variant, it may advantageously be provided that the system is programmed on the one hand to send the electricity produced by the installation 1 to the grid of the supplier at high-rate times, in such a way that the supplier purchases this electricity when it is most expensive, and on the other hand, to produce hydrogen and oxygen by electrolysis using the electricity supplied by the grid at low-rate times when the electricity is the cheapest.

In a second embodiment, the fuel cell 14 of the installation 1 could be replaced by a refuelling system (not shown) for a vehicle (not shown), which operates using hydrogen as a fuel. This vehicle could, in particular, be an electrically driven vehicle that draws its electricity from a fuel cell. In these conditions, the vehicle would be connected to the hydrogen tank of the installation, which tank would be provided with refuelling means provided to transfer the hydrogen contained in the tank (8) into a container of the vehicle.

It will be understood that according to the present invention, because of the principle by which the electricity produced by the solar panels is split between directly supplying the house 2 and producing hydrogen, the production cost of the hydrogen is reduced by comparison with the hydrogen produced by a prior art installation. Furthermore, the possibility of making renewable hydrogen available at a reduced price makes it possible to reduce the cost of a hydrogen-powered eco-friendly car.

1-10. (canceled)

11. An installation for the production and storage of renewable energy, provided for jointly supplying an electricity-consuming unit connected to a grid, wherein the installation comprises:
(a) means for generating electricity from renewable energy;
(b) an inverter to convert electricity supplied by the means for generating electricity from renewable energy of the installation to an alternating current compatible with the grid;
(c) a hydrogen production unit comprising
i. an electrolyser provided to produce hydrogen and oxygen when powered by the means for generating electricity from renewable energy;
ii. a first tank; and
iii. a first compressor disposed to inject the hydrogen provided by the electrolyser into the first tank;
(d) a detector provided to measure electrical power supplied by the grid to the electricity-consuming unit, wherein the means for generating electricity from renewable energy is disposed to supply energy produced by the means for generating electricity from renewable energy to the electricity-consuming unit as a priority until a connected load of the electricity-consuming unit is reached, and wherein the electricity-consuming unit comprises a branch connection unit connected to an output of the means for generating electricity from renewable energy, wherein the branch connection means is provided to direct electricity to the electrolyser, only when power measured by the detector is negative or zero, so as to direct to the electrolyser a remainder of electricity produced when power produced by the means for generating electricity from renewable energy exceeds the connected load.

12. An installation according to claim 11, wherein said branch connection means is provided to bring measured electrical power to zero or to keep the measured electrical power at zero.

13. An installation according to claim 11, wherein the hydrogen produced by the hydrogen production unit is provided to supply a fuel cell.

14. An installation according to claim 13, wherein the hydrogen produced by the hydrogen production unit is provided to supply the fuel cell of a vehicle, and wherein said installation further comprises hydrogen transfer means for transferring the hydrogen contained in the first tank of the installation into a container of the vehicle.

15. An installation according to claim 13, wherein said fuel cell is fixed and is part of said installation, and wherein said fuel cell is provided to supply electricity that said fuel cell produces to said electricity-consuming unit when the power produced by said means for generating electricity from renewable energy is less than the connected load of said electricity-consuming unit.

16. An installation according to claim 15, wherein said branch connection means is provided to bring said measured electrical power to zero or to keep said measured electrical power at zero, and said installation is provided to instruct the fuel cell to start up when said power measured by the detector is positive, and only at times when a cost of electricity from the grid is high.

17. An installation according to claim 14, wherein the installation further comprises a rectifier that enables a supply of electricity to the electrolyser from the grid so as to increase an amount of hydrogen contained in the first tank, but only when a cost of electricity from the grid is low.

18. An installation according to claim 11, wherein the hydrogen production unit further comprises a second tank and a second compressor for injecting oxygen provided by the electrolyser into the second tank.

19. An installation according to claim 18, wherein the oxygen and hydrogen produced by the electrolyser are provided to supply a fuel cell.

20. An installation according to claim 11, wherein said means for generating electricity from renewable energy comprises photovoltaic solar panels.

21. An installation according to claim 12, wherein the hydrogen produced by the hydrogen production unit is provided to supply a fuel cell.

22. An installation according to claim 21, wherein the hydrogen produced by the hydrogen production unit is provided to supply the fuel cell of a vehicle, and wherein said installation further comprises hydrogen transfer means for transferring the hydrogen contained in said first tank into a container of the vehicle.

23. An installation according to claim 22, wherein said fuel cell is fixed and is part of said installation, and wherein said fuel cell is disposed to supply electricity that said fuel cell produces to said electricity-consuming unit when the power produced by said means for generating electricity from renewable energy is less than the connected load of said electricity-consuming unit.

24. An installation according to claim 23, wherein the installation is provided to instruct the fuel cell to start up when power measured by the detector is positive, and only at times when a cost of electricity from the grid is high.

25. An installation according to claim 12, wherein the hydrogen production unit further comprises a second tank and a second compressor for injecting oxygen provided by the electrolyser into the second tank.

26. An installation according to claim 14, wherein the vehicle is a car.
